(19) United States
(12) Patent Application Publication
(10) Pub. No.: US 2020/0184157 A1
(43) Pub. Date: Jun. 11, 2020

(54) Bidirectional Translation System

(71) Applicant: EM-TECH Co., Ltd., Gyeongsangnam-do (KR)

(72) Inventors: Seung Kiu Jeong, Gyeongsangnam-do (KR); Cheon Myeong Kim, Gyeongsangnam-do (KR); Byung Min Yu, Seoul (KR)

(21) Appl. No.: 16/704,494

(22) Filed: Dec. 5, 2019

(30) Foreign Application Priority Data
Dec. 6, 2018 (KR) 1020180156379

(51) Int. Cl. G06F 40/58; G10L 15/22; G10L 15/30; H04R 25/00

(52) U.S. Cl. CPC G06F 40/58; G10L 15/22; H04R 25/554; H04R 25/604; G10L 15/30

(57) ABSTRACT

A bidirectional translation system includes a translation relay. The translation relay includes: a first communication part configured to communicate with at least one hearing aid; a second communication part configured to communicate with a communication terminal; a microphone configured to acquire speech; a speaker configured to emit sound; and a data processor configured to create first speech data containing speech acquired by the hearing aid and second speech data containing speech acquired by the microphone, send the first and second speech data to a communication terminal via the second communication part, receive, from the communication terminal, first translated speech data corresponding to the first speech data and second translated speech data corresponding to the second speech data, and emit a first translated speech contained in the first translated speech data through a speaker and apply the second translated speech data to the heating aid via the first communication part.

### TECHNICAL FIELD

The present invention relates to a translation system, and more particularly, to a bidirectional translation system that enables bidirectional translation between multiple languages by using a translation device mounted on one of multiple speakers in a conversation.

### BACKGROUND

In recent years, the number of foreigners who visited South Korea and the number of South Koreans who visited foreign countries have been increasing steadily every year. Especially, the number of Chinese visitors to South Korea is rapidly increasing with the increase in trade with China across all industries. Besides, it is easy to expect that large numbers of visitors from all over the world including Japan will visit South Korea. Moreover, the number of visitors to South Korea on business is increasing, too. Hence, communications between visitors from all over the world and Korean nationals are emerging as an important issue.

Foreign visitors and Korean tourists to foreign countries usually stay at hotels which offer full services. If a guest wants to communicate in their native language or communicate with people from other countries who only speak their native languages, the guest may communicate through an interpreter working at the hotel or through e-mail over the intemet, facsimile, etc. However, it is practically difficult for every hotel to have interpreters who speak various languages from all over the world, and there are other problems, including that interpreters should always be on standby, only one or two interpreters cannot offer satisfactory service to large numbers of guests, and guests cannot get interpretation service when they want it.

Therefore, this technical field demands technological developments for real-time simultaneous translation that allows tourists to talk with locals by using a communication terminal they carry around.

### SUMMARY

An object of the present invention is to provide a bidirectional translation system that enables bidirectional translation between multiple languages (e.g., between Korean and Japanese or between Korean and English) by using a translation device mounted on one of multiple speakers in a conversation.

According to an aspect of the present invention for achieving the above objects, there is provided a bidirectional translation system comprising a translation relay, the translation relay comprising: a first communication part that communicates with at least one hearing aid; a second communication part that communicates with a communication terminal; a microphone that acquires a speech; a speaker that emits sound; and a data processor that creates first speech data containing a speech acquired by the hearing aid and second speech data containing a speech acquired by the microphone, sends the first speech data and the second speech data to a communication terminal via the second communication part, receives, from the communication terminal, first translated speech data corresponding to the first speech data and second translated speech data corresponding to the second speech data, and emits a first translated speech contained in the first translated speech data through a speaker and applies the second translated speech data to the hearing aid via the first communication part to emit sound by the hearing aid.

In some embodiments, the data processor may reverse the speech contained in the first speech data and combine the same to the speech acquired by the microphone to create second speech data containing the combined speech.

In some embodiments, the data processor may communicate with a wireless microphone device via the first communication part, send third speech data containing a speech acquired by the microphone to the communication terminal via the second communication part, receive third translated speech data corresponding to the third speech data from the communication terminal, and apply the third translated speech data to the heating aid via the first communication part to emit sound by the hearing aid.

In some embodiments, the communication terminal may receive first, second, or third speech data from the translation relay, create first, second, or third translated speech data by directly translating the received first, second, or third speech data or create first, second, or third translation data containing the received first, second, or third speech data and translation language information and sends the same to a translation server, and receive first, second, or third translated speech data corresponding to the first, second, or third translation data from the translation server and send the created or received first, second, or third speech data to the translation relay.

In some embodiments, the hearing aid may have a microphone at least partially inserted into the user's hearing organ, that acquires a speech or speech vibration, creates first speech data containing the acquired speech or speech vibration to apply the same to the translation relay, and receives second or third translated speech data from the translation relay to emit sound.

While a conventional simultaneous translation device comes in the form of two ear sets and requires both a speaker and a listener to wear the ear sets, making them feel uncomfortable because it is unhygienic to wear the same ear sets other people might have worn, the present invention offers the advantage of allowing for bidirectional translation between different languages (e.g., between Korean and Japanese and between Korean and English) spoken by multiple speakers in a conversation by using a translation device mounted on one of the speakers.

Another advantage of the present invention is that it is easy to remove other speeches than a target speech when simultaneously recognizing the user (wearer)'s speech and the other person's speech, thus increasing the speech recognition rate.

### BRIEF DESCRIPTION OF THE DRAWINGS

FIG. 1 is a block diagram of a bidirectional translation system according to the present invention.

FIG. 2 is a perspective view of the first and second hearing aids and translation relay in FIG. 1.

### DETAILED DESCRIPTION

Hereinafter, an exemplary embodiment of the present disclosure will be described in detail with reference to the accompanying drawings. However, it should be understood that the present disclosure is not limited to the specific exemplary embodiment, but rather includes various modifications, equivalents and/or alternatives of the exemplary embodiment of the present disclosure. Regarding description of the drawings, like reference numerals may refer to like elements.

The term “have”, “may have”, “include”, “may include”, “comprise” or “may comprise” used herein indicates the presence of a corresponding feature (e.g., an element such as a numeric value, function, or part) and does not exclude the presence of an additional feature.

The term “A or B”, “at least one of A and/or B”, or “one or more of A and/or B” may include all possible combinations of items listed together. For example, the term “A or B”, “at least one of A and B”, or “at least one of A or B” may indicate all the cases of (1) including at least one A, (2) including at least one B, and (3) including at least one A and at least one B.

The term “first”, “second” or the like used herein may modify various elements regardless of order and/or priority, but does not limit the elements. Such terms may be used to distinguish one element from another element. For example, “a first user device” and “a second user device” may indicate different user devices regardless of order or priority. For example, without departing the scope of the present disclosure, a first element may be referred to as a second element and vice versa.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) between the element and the other element.

The expression “configured to” used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may refer to a dedicated processor (e.g. embedded processor) only for performing the corresponding operations or a general-purpose processor (e.g., central processing unit (CPU) or application processor (AP)) that may perform the corresponding operations by executing one or more software programs stored in a memory device.

In the present disclosure, the terms are used to describe specific embodiments, and do not limit the present disclosure. As used herein, the singular forms are intended to include the plural forms as well, unless the context clearly indicates otherwise. Unless defined differently, all terms used herein, which include technical terms or scientific terms, have the same meanings as those commonly understood by a person skilled in the art to which the present disclosure pertains. Such terms as those defined in a generally used dictionary are to be interpreted to have the same meanings as the contextual meanings in the relevant field of art, and are not to be interpreted to have ideal or excessively formal meanings unless clearly defined in the present specification. In some cases, even terms defined in the present disclosure should not be interpreted to exclude embodiments of the present disclosure.

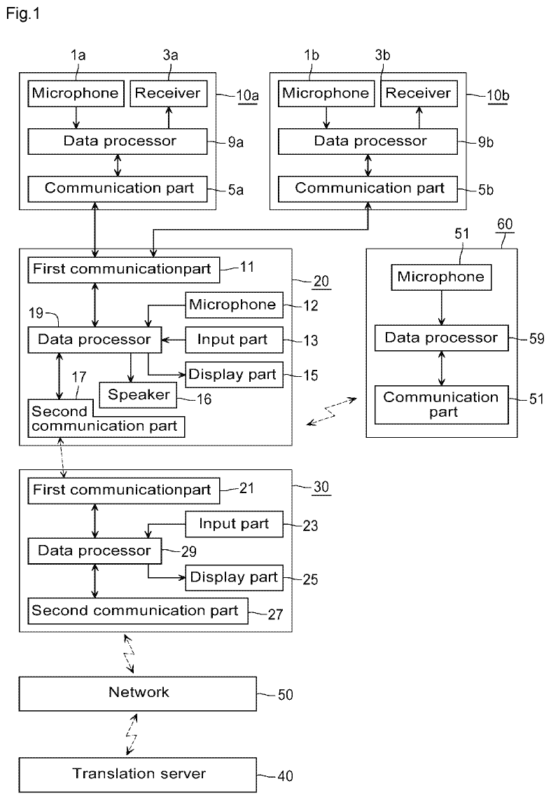

FIG. 1 is a block diagram of a bidirectional translation system according to the present invention.

The bidirectional translation system may include first and second hearing aids 10a and 10b with a speech acquisition function and a speech output function, a translation relay 20 that performs wired or wireless communication with the first and second hearing aids 10a and 10b and performs wired or wireless communication with a communication terminal 30, the communication terminal 30 that performs wired or wireless communication with the translation relay 20 and performs wireless communication with a translation server 40 over a network 50, the translation server 40 that performs translation and performs wireless communication with the communication terminal 30, and the network 50 that enables wireless communication between the communication terminal 30 and the translation server 40. Further, the bidirectional translation system may include a wireless microphone device 60 that is mounted at a position where the user wants it to be and performs wireless communication with the translation relay 20.

In this specification, it is illustrated that a conversation between multiple speakers, including a user (wearer) and the other person talking with the user, is translated between different languages, at least one of the first and second hearing aids 10a and 10b is at least partially inserted into the left or right hearing organs (e.g., earhole), and the translation relay 20 sits or is mounted on the user's body or clothing. That is, at least one of the first and second hearing aids 10a and 10b and the translation relay 20 are all worn by a single user (wearer), and a conversation with at least one other person is translated.

First of all, the user may enter information about languages to be translated bidirectionally (e.g., an input language (wearer (user)—Korean), an output language (the other person—Japanese), etc.) into the communication terminal 30, or the communication terminal 30 may independently determine the languages to be translated bidirectionally. In this embodiment, the wearer (user) speaks Korean and the other person speaks Japanese, the user wears the first hearing aid 10a and the translation relay 20, and communication between the first hearing aid 10a and the translation relay 20, communication between the translation relay 20 and the communication terminal 30, and/or communication between the communication terminal 30 and the translation server 40 are all possible.

First of all, a process of providing translation of the Korean spoken by the user into the other person's language, i.e., Japanese will be described. The first heating aid 10a acquires the user's speech through a microphone (1a of FIG. 1), which is at least partially inserted into the user's hearing organ, and applies speech data containing the acquired speech to the translation relay 20. The translation relay 20 applies the applied speech data to the communication terminal 30, and the communication terminal 30 translates the applied speech by implementing a built-in translation algorithm on the applied speech data to create translated speech data containing a translated speech, or sends translation data containing speech data and translation language information (translation from Korean to Japanese) to the translation server 40 over the network 50 and receives translated speech data from the translation server 40. Here, the translation server 40 translates the applied speech by implementing a built-in translation algorithm on the received speech data based on the translation language information contained in the translation data, to create translated speech data containing a translated speech and send it to the communication terminal 30. The communication terminal 30 applies the created translated speech data or the received translated speech data to the translation relay 20. The translation relay 20 emits the applied translated speech data through a speaker 16 so that the other person hears a Japanese translation of the Korean spoken by the user.

Next, a process of providing translation of Japanese spoken by the other person into the user's language, i.e., Korean will be described. The translation relay 20 acquires the other person's speech through a microphone 12, and applies speech data containing the acquired speech to the communication terminal 30. The communication terminal 30 translates the applied speech by implementing a built-in translation algorithm on the applied speech data to create translated speech data containing a translated speech, or sends translation data containing speech data and translation language information (translation from Japanese to Korean) to the translation server 40 over the network 50 and receives translated speech data from the translation server 40. Here, the translation server 40 translates the applied speech by implementing a built-in translation algorithm on the received speech data based on the translation language information contained in the translation data, to create translated speech data containing a translated speech and send it to the communication terminal 30. The communication terminal 30 applies the created translated speech data or the received translated speech data to the translation relay 20. The translation relay 20 applies the translated speech contained in the applied translated speech data to the first heating aid 10a, and the first hearing aid 10a emits the applied translated speech through a receiver 3a so that the user hears a Korean translation of the Japanese spoken by the other person.

As for the above-mentioned translation language information, the input language and the output language may be reversed depending on how is being targeted, as in information (input language—Korean, output language—Japanese) needed for translating the user's speech and information (input language—Japanese, output language—Korean) needed for translating the other person's speech).

For the above-mentioned bidirectional translation between the user (wearer)'s speech and the other person's speech, a detailed configuration of the first and second hearing aids 10a and 10b, translation relay 20, communication terminal 30, and translation server 40 of the bidirectional translation system according to the present invention will be described below. However, the network 50, which is a communication system that allows for wired and/or wireless communication, is a well-known to a person having ordinary skill in the art, so a detailed description thereof will be omitted.

First of all, the first hearing aid 10a includes a microphone 1a that is at least partially inserted into the wearer's hearing organ and acquires the wearer's speech, a receiver 3a that emits (or outputs) the speech to the wearer's hearing organ, a communication part 5a that performs wired or wireless communication with the translation relay 20, and a data processor 9a that performs speech acquisition and speech output (or emission) functions. Although a power supply part (not shown) for supplying electric power into the first hearing aid 10a is provided in the first hearing aid 10a, a detailed description thereof will be omitted since it is a well-known to a person having ordinary skill in the art.

The microphone 1a is configured in such a way as to be at least partially inserted into the wearer's hearing organ, and acquires a speech vibration delivered to the hearing organ or a speech in the hearing organ and applies the speech vibration or speech (hereinafter, collectively referred to as “speech”) to the data processor 9a. A casing of the first hearing aid 10a is configured in such a way as to incorporate the microphone 1a and allow at least part of the microphone 1a to be inserted into the hearing organ.

The receiver 3a emits a translated speech applied from the data processor 9a so that the wearer hears the translated speech. The receiver 3a is positioned outside where the microphone 1a is fitted, within the casing of the first hearing aid 10a, and embedded into the casing, at a position where it is not inserted into the wearer's hearing organ.

The communication part 5a is a component that performs wired or wireless communication with the translation relay 20—for example, it may be implemented as a speech transmission cable for wired communication or a wireless communication module (e.g., Bluetooth) for performing wireless communication.

The data processor 9a may be implemented as a processor (e.g., CPU, microprocessor, etc.) for performing the speech acquisition function and the speech output function. The data processor 9a creates speech data (first speech data) containing a speech applied from the microphone la, and applies or sends the created first speech data to the translation relay 20 via the communication part 5a or by control of the communication part 5a. Also, the data processor 9a receives the other person's translated speech data (second translated speech data) applied or sent from the translation relay 20 via the communication part 5a, and applies the translated speech contained in the received second translated speech data to the receiver 3a so that the speech is emitted.

The second hearing aid 10b has the same structure as the first hearing aid 10a.

Next, the translation relay 20 includes a first communication part 11 that performs wired or wireless communication with the first and/or second hearing aid 10a and 10b, a microphone 12 that acquires a speech or sound, an input part 13 that acquires an input (e.g., power on/off, translation function on/off, volume up/down control, etc.) from the user (wearer), a display part 15 that shows the power status (on/off) and shows the status (on/off) of the translation function, a speaker 16 that emits a speech or sound, a second communication part 17 that performs wireless communication with the communication terminal 30, and a data processor 19 that performs speech reception and transmission functions and translated speech reception and transmission functions. However, a power supply part (not shown) for supplying electric power into the communication relay 20, the microphone 12, the input part 13, the display part 15, and the speaker 16, are well-known to a person having ordinary skill in the art, so detailed descriptions thereof will be omitted.

The first communication part 11 is a component that performs wired or wireless communication with the first and/or second hearing aid 10a and 10b—for example, it may be implemented as a speech transmission cable for wired communication or a wireless communication module (e.g., Bluetooth) for performing wireless communication.

The second communication part 17 is a component that performs wired or wireless communication with the communication terminal 30—for example, it may be implemented as a wireless communication module (e.g., Bluetooth) for performing wireless communication. The first and second communication parts 11 and 17 may be implemented as a single communication module.

The data processor 19 includes a processor (e.g., CPU, microprocessor, etc.) for performing the speech reception and transmission functions, the translated speech reception and transmission functions, and/or a speech processing function, and a storage space for storing a speech processing algorithm for the speech processing function.

First of all, for the speech reception and transmission functions, the data processor 19 receives first speech data from the first and/or second hearing aid 10a and 10b via the first communication part 11 or by control of the first communication part 11, and sends the received first speech data to the communication terminal 30 by control of the second communication part 17. Also, the data processor 19 creates second speech data containing a speech (e.g., the other person's speech and/or the wearers speech) acquired by the microphone 12 and sends it to the communication terminal 30 by control of the second communication part 17.

Moreover, in the creation of second speech data, the data processor 19 performs speech processing to remove or reduce the wearer's speech contained in the second speech data by using the speech (which is mostly or entirely the wearer's speech) contained in the first speech data, thereby improving the other person's speech recognition rate. For example, the data processor 19 reverses the phase of the wearer's speech (speech acquired by the microphone 1a) contained in the first speech data, combines it to the speech acquired by the microphone 12, and includes the combined speech in the second speech data, thereby removing or reducing the wearer's speech and increasing the ratio of the other person's speech in the second speech data.

In addition, for the translated speech reception and transmission functions, the data processor 19 receives first translated speech data corresponding to the first speech data from the communication terminal 30 via the second communication part 17, and applies the translated speech contained in the first translated speech data to the speaker 16 to output the speech, thereby allowing the other person to hear the wearer's translated speech. Further, the data processor 19 receives second translated speech data corresponding to the second speech data from the communication terminal 30 via the second communication 17 and applies the second translated speech data to the first and/or hearing aid 10a and 10b via the first communication part 11.

Next, the communication terminal 30 includes a first communication part 21 that performs wired or wireless communication with the translation relay 20, an input part 23 that acquires an input (input for enabling or disabling a translation function, a selection/input of languages to be translated bidirectionally, etc.) from the user, a display part 25 that shows the enabled/disabled state of the translation function and shows the languages to be translated bidirectionally, a second communication part 27 that performs wired or wireless communication with the translation server 40 over the network 50, and a data processor 29 that performs translation of the first and second speech data applied from the translation relay 20 and sends first and second translated speech data to the translation relay 20. However, a power supply part (not shown) for supplying electric power into the communication terminal 30, the input part 23, and the display part 25 are well-known to a person having ordinary skill in the art, so detailed descriptions thereof will be omitted.

The first communication part 21 is a component that performs wired or wireless communication with the translation relay 20—for example, it may be implemented as a wireless communication module (e.g., Bluetooth) for performing wireless communication.

The second communication part 27 is a component that performs wired or wireless communication with the translation server 40—for example, it may be implemented as a wireless communication module for performing wireless communication. The first and second communication parts 21 and 27 may be implemented as a single communication module.

The data processor 29 includes a processor (e.g., CPU, microprocessor, etc.) for performing the reception and transmission of first and second speech data, the reception and transmission of first and second translated speech data, or the creation of first and second translated speech data, and a storage space for storing information about the enabling/disabling of a translation function, translation language information about languages to be translated bidirectionally, and a translation algorithm for creating a translated speech.

The data processor 29 acquires and stores an input for enabling or disabling the translation function through the input unit 23, and enables or disables the translation function.

Also, the data processor 29 acquires an input or selection of languages to be translated bidirectionally through the input part 23, and stores the translation language information corresponding to the languages to be translated bidirectionally.

First of all, as for the reception and transmission of speech data, the data processor 29 receives first or second speech data from the translation relay 20 via the first communication part 21, and, if the translation server 40 performs translation, creates first or second translation data containing the received first or second speech data and translation language information and sends it to the translation server 40 via the second communication part 27. For example, the first translation data contains first speech data and translation language information (translation from Korean to Japanese), and the second translation data contains second speech data and translation language information (translation from Japanese to Korean). Also, in a case where the data processor 29 performs direct translation, it stores the first or second translation data in the storage space.

Moreover, as for the reception and transmission of first and second translated speech data, the data processor 29 receives first or second translated speech data respectively corresponding to the first or second translation data from the translation server 40, and sends the received first or second translated speech data to the translation relay 20 via the first communication part 21.

In addition, the data processor 29 creates a translated speech for the speech contained in the first or second speech data by implementing the stored translation algorithm, and creates first or second translated speech data and sends it to the translation relay 20 via the first communication part 21.

Further, the data processor 29 may store a translation application for enabling/disabling the translation function, selecting/inputting the languages to be translated bidirectionally, receiving and sending speech data, creating and sending translation data, and performing direct translation, and execute the translation application.

Further, the translation server 40 includes a communication part (not shown) that receives first or second translation data and sends first or second translated speech data, and a data processor (not shown) that translates the speech contained in the first or second translation data on the basis of the translation language information to create first or second translated speech data and apply it to the communication part. However, the communication part and the data processor are well-known to a person having ordinary skill in the art, so detailed descriptions thereof will be omitted.

The wireless microphone device 60 includes a microphone 51 for acquiring a speech, a communication part 53 for performing wireless communication with the translation relay 20, and a data processor 59 for performing speech acquisition and speech transmission functions. Although a power supply part (not shown) for supplying electric power is provided in the wireless microphone device 60, a detailed description thereof will be omitted since it is a well-known to a person having ordinary skill in the art. The wireless microphone device 60 is a device that is easy to move, and may be therefore mounted at a position the user wants it to be.

The microphone 51 acquires a speech from the outside and applies it to the data processor 59.

The communication part 53 is a component that performs wired or wireless communication with the translation relay 20—for example, it may be implemented as a wireless communication module (e.g., Bluetooth) for performing wireless communication. The communication part 53 may perform wireless communication with the first or second communication part 11 and 17, and, in this embodiment, is described as communicating wirelessly with the first communication part 11.

The data processor 59 may be implemented as a processor (e.g., CPU, microprocessor, etc.) for performing the speech acquisition function and the speech transmission function. The data processor 59 creates third speech data containing a speech applied from the microphone 51, and applies or sends the created third speech data to the translation relay 20 via the communication part 53.

Moreover, the data processor 19 receives third speech data via the first communication part 11 and sends the third speech data received via the second communication part 17 to the communication terminal 30. The data processor 29 of the communication terminal 30 receives the third speech data via the first communication part 21, and creates third translation data containing the received third speech data and translation language information and sends it to the translation server 40 over the network 50 by control of the second communication part 27, or independently creates third translation data containing a translated speech corresponding to the third speech data by using a translation algorithm. The translation server 40 translates the third speech data contained in the third translation data on the basis of the translation language information, like it does on the first and second translation data, and creates third translated speech data containing a translated speech and sends it to the communication terminal 30. The data processor 29 of the communication terminal 30 receives the third translated speech data via the second communication part 27, and sends the third translated speech data it has received or has independently created to the translation relay 20 via the first communication part 21. The data processor 19 of the translation relay 20 receives the third translated speech data via the second communication part 17, and applies the third translated speech data to the first or second hearing aid 10a and 10b via the first communication part 11. The data processors 9a and 9b of the first and second hearing aids 10a and 10b receive the third translated speech data via the communication parts 5a and 5b, respectively, and allow the translated speech contained in the third translated speech data to be emitted through the receivers 3a and 3b, respectively. By means of the wireless microphone device 60, the user is able to clearly hear the other person's speech at a great distance.

In addition, if the translation functions of the translation relay 20 and communication terminal 30 are disabled, the communication terminal 30 may send multimedia data (e.g., audio, music, etc.) to the translation relay 20 or send playback data of multimedia data to the translation relay 20. The translation relay 20 plays the received multimedia data or receives the playback data, and emits sound through the speaker 16 and/or first or second hearing aid 10a and 10b.

In another example, the first and second heating aids 10a and 10b do not include the data processors 9a and 9b, and the communication parts 5a and 5b may be implemented as a cable (e.g., wires, etc.) for wired communication to transmit signals. That is, the microphones 1a and 1b of the first and second hearing aids 10a and 10b acquire a speech and apply it to the first communication part 11 of the translation relay 20 via the communication parts 5a and 6b, respectively, and the data processor 19 then creates first speech data containing the acquired speech and sends it to the communication terminal 30. A subsequent process to be performed by the communication terminal 30 is identical to the above-described process. Also, the data processor 19 receives second translated speech data corresponding to second speech data from the communication terminal 30, and applies the translated speech contained in the second translated speech data to the communication parts 5a and 5b of the first and second hearing aids 10a and 10b via the first communication part 11. The receivers 3a and 3b then receive the translated speech applied to the communication parts 5a and 6b, respectively, and emit sound. In this embodiment, the data processor 19 of the translation relay 20 controls the processing of speech from the microphones 1a and 1b and the transmission of speech to the receivers 3a and 3b.

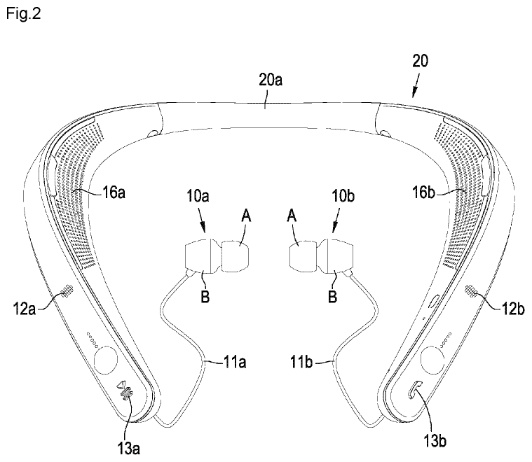

FIG. 2 is a perspective view of the first and second hearing aids 10a and 10b and translation relay 20 of FIG. 1.

The translation relay 20 includes an annular casing 20a that sits around the user's neck or over the user's shoulder, at least part of which forms an open space and which is formed by connecting two separate ends, first and second connecting lines 11a and 11b respectively connected to the first and second hearing aids 10a and 10b, microphones 12a and 12b (collectively referred to as 12 in FIG. 1) provided on the side (outer side) of the casing 20a, input parts 13a and 13b (collectively referred to as 13 in FIG. 1) provided at opposite ends of the casing 20a, and speakers 16a and 16b (collectively referred to as 16 in FIG. 1) provided on opposite sides of the casing 20a.

The first and second hearing aids 10a and 10b each have an insertion portion A that is at least partially inserted into the hearing organ and a connecting portion B connected to the insertion portion A, with the first and second connecting lines 11a and 11b being connected to one end. The microphones 1a and 1b are fitted in the insertion portions A, and the receivers 3a and 3b are fitted in the connecting portions B. The insertion portions A are made of elastic material.

In this embodiment the first communication part 11 has first and second connecting lines 11a and 11b that enable a wired connection.

At least some of devices (e.g., processors or their functions) or methods (e.g., operations) according to various embodiments may be implemented by, for example, a command stored in computer-readable storage media in the form of a program module. If the command is executed by at least one processor, the at least one processor may perform a function corresponding to the command. The computer-readable storage media may be memory, for example.

The computer-readable storage media may include magnetic media (e.g., a hard disk, a floppy disk and magnetic media (e.g., magnetic tape), optical media (e.g., CD-ROM and DVD (digital versatile disc)), magneto-optical media (e.g., floptical disk)), and a hardware device (e.g., ROM, RAM, or flash memory). In addition, the program command may include not only a machine code made by a compiler, but also a high-level language code that can be executed by a computer using an interpreter and the like. The aforementioned hardware device may be configured to operate as one or more software modules to perform operations according to various embodiments of the present disclosure, and vice versa.

A processor or its functions according to various embodiments of the present invention may include one or more of the above-described components, some of which may be omitted, or may further include other additional components. The operations executed by a module, a programming module, or other components according to various embodiments of the present invention may be executed in a sequential, parallel, iterative or heuristic manner. In addition, some operations may be executed in a different order or omitted, or other operations may be added.

As explained above, the present invention is not limited to the above-described specific preferred embodiment, and those having ordinary skill in the technical field to which the present invention pertains can make various modifications and variations without departing from the gist of the present invention that is claimed in the attached claims. Such modifications and variations fall within the scope of the claims.

What is claimed is:

1. A bidirectional translation system comprising a translation relay, the translation relay comprising:
first communication part configured to communicate with at least one heating aid;
second communication part configured to communicate with a communication terminal;
microphone configured to acquire speech;
speaker configured to emit sound; and
data processor configured to create first speech data containing speech acquired by the at least one hearing aid and second speech data containing speech acquired by the microphone, send the first speech data and the second speech data to the communication terminal via the second communication part, receive, from the communication terminal, first translated speech data corresponding to the first speech data and second translated speech data corresponding to the second speech data, and emit a first translated speech contained in the first translated speech data through the speaker and apply the second translated speech data to the at least one hearing aid via the first communication part to emit sound by the at least one hearing aid.

2. The bidirectional translation system of claim 1, wherein the data processor is configured to reverse the speech contained in the first speech data and combine the same to the speech acquired by the microphone to create second speech data containing the combined speech.

3. The bidirectional translation system of claim 2, wherein the bidirectional translation system comprises a communication terminal configured to receive first, second, or third speech data from the translation relay, create first, second, or third translated speech data by directly translating the received first, second, or third speech data or create first, second, or third translation data containing the received first, second, or third speech data and translation language information and send the same to a translation server, and receive first, second, or third translated speech data corresponding to the first, second, or third translation data from the translation server and send the created or received first, second, or third speech data to the translation relay.

4. The bidirectional translation system of claim 2, wherein the bidirectional translation system comprises a hearing aid having a microphone at least partially inserted into a hearing organ of a user and configured to acquire speech or speech vibration, create first speech data containing the acquired speech or speech vibration to apply the same to the translation relay, and receive second or third translated speech data from the translation relay to emit sound.

5. The bidirectional translation system of claim 1, wherein the data processor is configured to communicate with a wireless microphone device via the first communication part, send third speech data containing speech acquired by the microphone to the communication terminal via the second communication part, receive third translated speech data corresponding to the third speech data from the communication terminal, and apply the third translated speech data to the at least one hearing aid via the first communication part to emit sound by the at least one heating aid.

6. The bidirectional translation system of claim 5, wherein the bidirectional translation system comprises a communication terminal configured to receive first, second, or third speech data from the translation relay, create first, second, or third translated speech data by directly translating the received first, second, or third speech data or create first, second, or third translation data containing the received first, second, or third speech data and translation language information and send the same to a translation server, and receive first, second, or third translated speech data corresponding to the first, second, or third translation data from the translation server and send the created or received first, second, or third speech data to the translation relay.

7. The bidirectional translation system of claim 5, wherein the bidirectional translation system comprises a hearing aid having a microphone at least partially inserted into a hearing organ of a user and configured to acquire speech or speech vibration, create first speech data containing the acquired speech or speech vibration to apply the same to the translation relay, and receive second or third translated speech data from the translation relay to emit sound.

8. The bidirectional translation system of claim 1, wherein the bidirectional translation system comprises a communication terminal configured to receive first, second, or third speech data from the translation relay, create first, second, or third translated speech data by directly translating the received first, second, or third speech data or create first, second, or third translation data containing the received first, second, or third speech data and translation language information and send the same to a translation server, and receive first, second, or third translated speech data corresponding to the first, second, or third translation data from the translation server and send the created or received first, second, or third speech data to the translation relay.

9. The bidirectional translation system of claim 1, wherein the bidirectional translation system comprises a hearing aid having a microphone at least partially inserted into a hearing organ of a user and configured to acquire speech or speech vibration, create first speech data containing the acquired speech or speech vibration to apply the same to the translation relay, and receive second or third translated speech data from the translation relay to emit sound.
